(19) United States
(12) Patent Application Publication
(10) Pub. No.: US 2016/0357258 A1
(43) Pub. Date: Dec. 8, 2016

(54) Apparatus for Providing Haptic Force Feedback to User Interacting With Virtual Object in Virtual Space

(71) Applicant: Center of Human-Centered Interaction for Coexistence, Seoul (KR)

(72) Inventors: Ki Won Yeom, Paju-si (KR); Joung Huem Kwon, Seoul (KR); Ji Yong Lee, Seoul (KR); Bum Jae You, Seoul (KR)

(73) Assignee: Center of Human-Centered Interaction for Coexistence, Seoul (KR)

(21) Appl. No.: 15/171,167

(22) Filed: Jun. 2, 2016

(30) Foreign Application Priority Data
Jun. 5, 2015 (KR) 10-2015-0080185

(51) Int. Cl. G06F 3/01

(52) U.S. Cl. CPC G06F 3/016; G06F 3/011

(57) ABSTRACT

An apparatus for providing haptic force feedback to a user interacting with a virtual object in a virtual space is provided. The apparatus includes a force-feedback provision unit providing a sensation of touch arising from an interaction with the virtual object to at least a portion of the user's body. A processor unit performs (i) receiving at least one of a first force-feedback control data generated based on vector information on a motion of the at least a portion of the user's body and information on the virtual object and a second force-feedback control data generated based on image information the information on the virtual object from the external terminal, or (ii) generating at least one of the first and second force-feedback control data.

### BACKGROUND OF THE INVENTION

### Field of the Invention

The present invention relates generally to an apparatus for providing haptic force feedback to a user interacting with a virtual object in a virtual space.

### Description of the Related Art

As 3D image-forming technology develops, research on virtual reality is being actively carried out. A technique for an interaction in virtual reality is developing continuously, and the most crucial factor is to implement a technique for creating a sense of realism in the virtual reality. The senses used in the interaction in the virtual space include sight, hearing, taste, smell, and touch, and haptic technology using the sensation of touch is the technology that is available to a variety of fields such as medicine, games, robots, etc.

The present invention is intended to propose an apparatus that is held on a portion of the user's body so as to provide force feedback arising from the interaction in a virtual space to the user.

### SUMMARY OF THE INVENTION

Accordingly, the present invention has been made keeping in mind the above problems occurring in the related art, and an object of the present invention is to enable a user manipulating a 3D virtual object in a 3D virtual space to realize, from a virtual article, real sensation of touch that the user can feel as he/she touches or moves a certain real article in a real space.

Another object of the present invention is to enable 3D eyeglasses or a head-mounted device (HMD) interacting with a virtual article to obtain a direct sensation of touch for the virtual article that is similar to a real sensation of touch that is obtained when a certain real article is manipulated in a real space.

A further object of the present invention is to enable physical feedback in a virtual environment system so as to prevent a phenomenon that a 3D object separates a certain distance from a virtual article without touch, or penetrates through the virtual article.

In order to achieve the above objects, according to one aspect of the present invention, there is provided an apparatus for providing haptic force feedback to a user interacting with a virtual object in a virtual space, the apparatus including: a casing wearable around at least a portion of the user's body; a force-feedback provision unit coupled directly or indirectly to the casing and having a first end directly or indirectly touching at least a portion of the user's body and a second end coupled directly or indirectly to the casing through an elastic member to allow the first end to provide the sensation of touch arising from an interaction with the virtual object to the at least a portion of the user's body; a communication unit coupled directly or indirectly to the casing to communicate with an external terminal; and a processor unit coupled to directly or indirectly to the casing and configured to perform (i) a process of receiving at least one of: a first force-feedback control data generated based on vector information on a motion of the at least a portion of the user's body wearing the casing and information on the virtual object; and a second force-feedback control data generated based on image information on a motion of the at least a portion of the user's body wearing the casing and information on the virtual object, from the external terminal via the communication unit so as to control the force-feedback provision unit, or (ii) a process of generating at least one of the first and second force-feedback control data so as to control the force-feedback provision unit.

According to the foregoing, the present invention provides an effect of enabling a user manipulating a 3D virtual object in a 3D virtual space to realize, from a virtual article, real sensation of touch that the user can feel as he/she touches or moves a certain real article in a real space.

Further, the present invention provides an effect of enabling 3D eyeglasses or a head-mounted device (HMD) interacting with a virtual article to obtain a direct sensation of touch for the virtual article that is similar to a real sensation of touch that is obtained when a certain real article is manipulated in a real space, thereby improving an interaction and manipulation performance with respect to the virtual article.

Still further, the present invention provides an effect of enabling a user touching a virtual object during interacting with the virtual object using a 3D sub-visualization device to receive the touch feedback, thereby providing a real sensation of touch or impact for the virtual object and allowing the user to feel realism in manipulating the virtual object.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a view illustrating a schematic configuration of an entire system according to embodiments of the present invention;

FIG. 2 is a view illustrating appearances of an apparatus for providing a user with the sensation of touch for a virtual object according to embodiments of the present invention;

FIG. 3 is a view illustrating an internal configuration of an apparatus for providing a user with the sensation of touch for a virtual object according to embodiments of the present invention;

FIG. 4 is a view illustrating the configuration of a force-feedback provision unit for providing a user with the sensation of touch according to embodiments of the present invention; and

FIGS. 5A and 5B are cross-sectional views illustrating an assembly of a plurality of force-feedback provision units for providing a user with the sensation of touch according to embodiments of the present invention.

### DETAILED DESCRIPTION OF THE INVENTION

Reference will now be made in greater detail to exemplary embodiments of the invention, an example of which is illustrated in the accompanying drawings. These embodiments are described in detail such that a person skilled in the art can sufficiently implement those embodiments through the description. It is noted that, although being different from each other, various embodiments are not required to be necessarily mutually exclusive. For example, specified shapes, structures, and features of an embodiment described herein may be implemented into other embodiments without departing from the spirit and scope of the present invention. Further, it should be understood that positions or arrangements of individual elements in respective disclosed embodiments may be changed into other positions or arrangements without departing from the spirit and scope of the present invention. Accordingly, the following description is not intended to be limitative, and if appropriately described, the scope of the present invention is only defined by the appended claims and equivalents thereof. In the figures, like reference numerals refer to the same or similar functions throughout many aspects.

Hereinafter, preferred embodiments of the present invention will be described in detail with reference to the accompanying drawings in order to allow an ordinary skilled person in the art to which the present invention pertains to easily implement the invention.

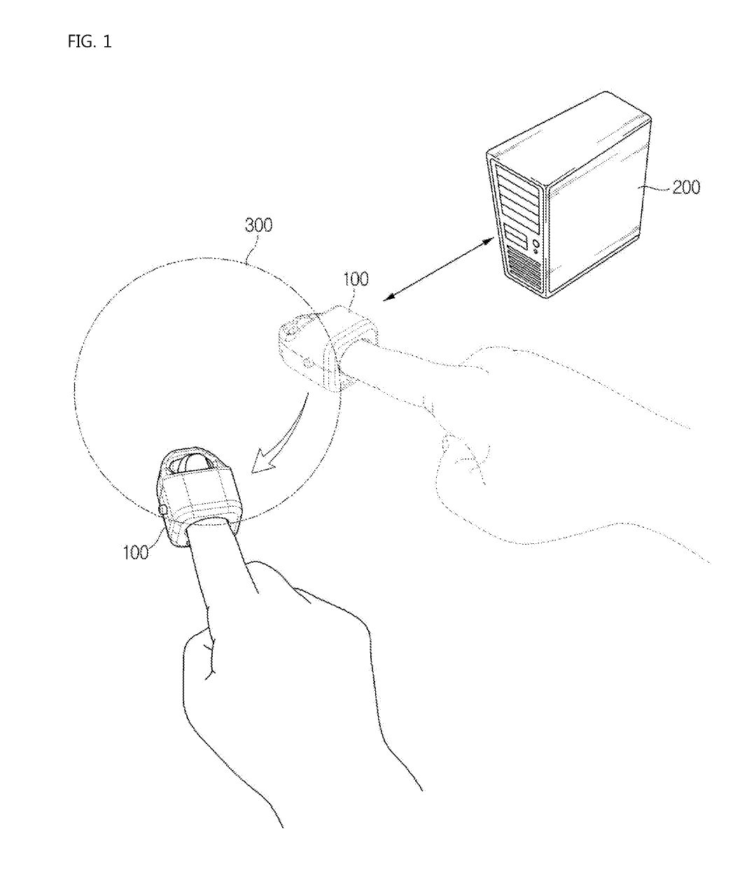

FIG. 1 is a view illustrating a schematic configuration of an entire system according to embodiments of the present invention.

As illustrated in FIG. 1, the entire system according to embodiments of the present invention includes a force-feedback provision apparatus 100, an external terminal 200, and a virtual object 300. For reference, force feedback provided to a user through the force-feedback provision apparatus 100 means the sensation of touch, such as muscular sensation, texture, a sense of direction, etc., occurring when the user touches an object.

The force-feedback provision apparatus 100 according to embodiments of the present invention may be configured into a shape wearable around at least a portion of the user's body, so a user can manipulate a virtual object 300, wearing the force-feedback provision apparatus 100. Here, the virtual object 300 may be a virtual object output in a certain 3D space, but may also include a 2D virtual object.

In order to provide a user with force feedback arising from an interaction with the virtual object 300 through the force-feedback provision apparatus 100, there is a need to provide a process of checking a touch state between the force-feedback provision apparatus 100 worn by the user and the virtual object 300 and a process of generating data to control the force-feedback provision apparatus 100 according to the touch state. These processes may be carried out through the force-feedback provision apparatus 100 or the external terminal 200 operatively associated with the force-feedback provision apparatus 100. This will be described later. The external terminal 200 may include any of digital devices, such as desktop computers, notebook computers, workstations, PDAs, web pads, mobile phones, head-mounted devices (HMDs), etc., so long as they have a calculation capability through memories and microprocessors. FIG. 1 shows an example where a user manipulates the virtual object 300, wearing the force-feedback provision apparatus 100 around his/her finger.

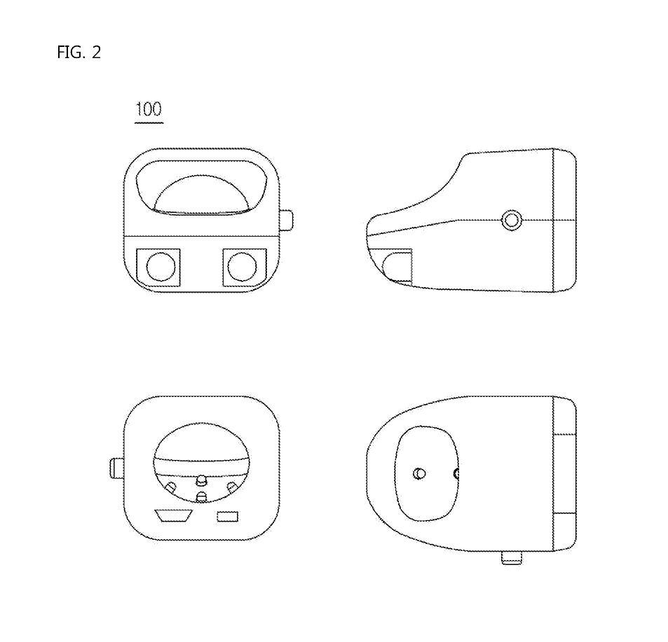

FIG. 2 is a view illustrating appearances of the force-feedback provision apparatus 100 for providing a user with the sensation of touch for the virtual object 300 from different angles according to embodiments of the present invention.

Referring to FIG. 2, although the force-feedback provision apparatus 100 according to embodiments of the present invention is configured as being wearable around the user's finger, the present invention is not limited thereto, but may include other forms if they are wearable around at least a portion of the user's body. Further, the force-feedback provision apparatus 100 worn around the user's finger may have a cylindrical shape in addition to the shape shown in FIG. 2, and a ring-type force-feedback provision apparatus 100 may also fall within the scope of the present invention if it is wearable around the user's finger. Of course, the ring does not essentially require a completely circular form having a 360-degree circumference, but may have a form having a partial circumference circumferentially extending at least a predetermined angle.

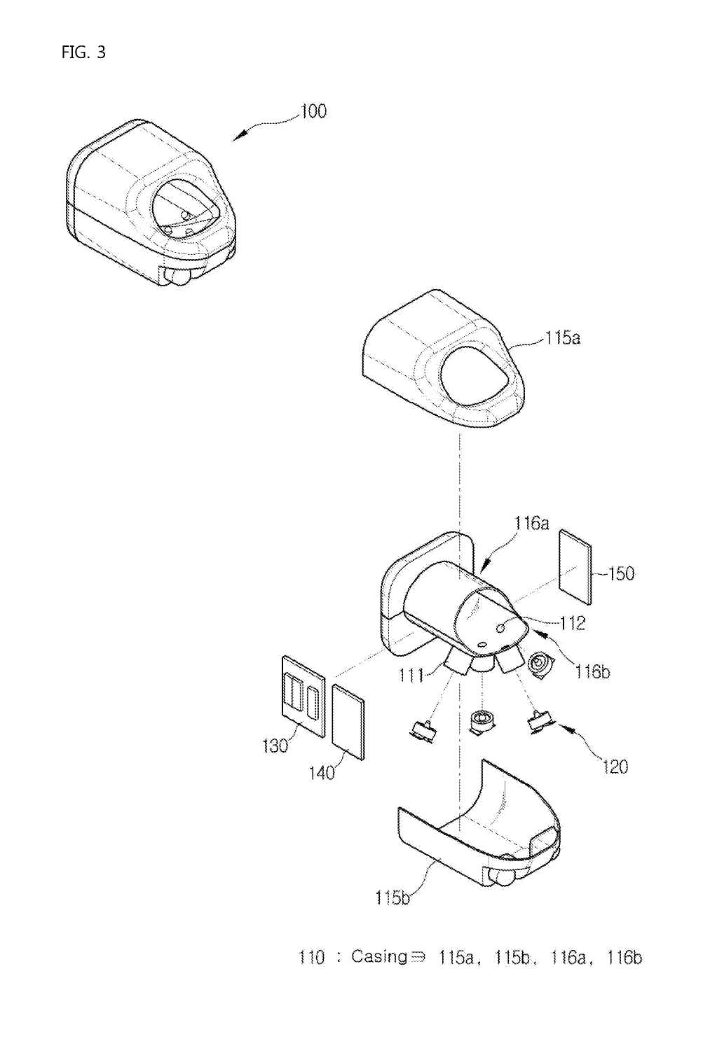

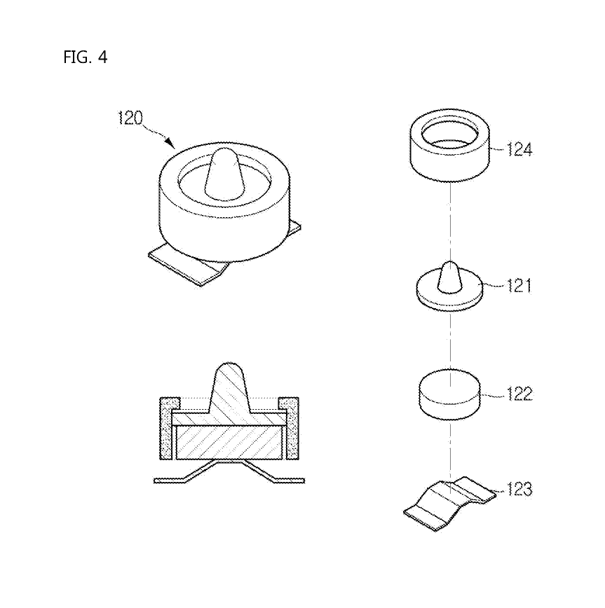

Specifically, the force-feedback provision apparatus 100 according to embodiments of the present invention may be provided with a plurality of force-feedback provision units 120 for providing force feedback to the user's finger, so that sensation of touch such as muscular sensation, texture, a sense of direction, etc. can be provided to the user by controlling the force-feedback provision units 120. Although the force-feedback provision unit 120 is configured such that a first end thereof contacts the user's finger according to embodiments of the present invention, the first end may indirectly contact the user's finger, since a cover may be disposed above the force-feedback provision unit 120. The force-feedback provision unit 120 will be described in detail with reference to FIGS. 3 and 4.

FIG. 3 is an exploded view illustrating an internal configuration of a force-feedback provision apparatus 100 for providing a user with the sensation of touch for a virtual object 300 according to embodiments of the present invention.

As illustrated in FIG. 3, the force-feedback provision apparatus 100 includes a casing 110, a force-feedback provision unit 120, a communication unit 130, a processor unit 140, and a power supply 150.

The casing 110 has a shape wearable around at least a portion of the user's body. For example, the casing may consist of an outer casing part 115 and an inner casing part 116 that can be coupled together. Here, the outer casing part 115 may consist of first and second outer casing parts 115a and 115b that can be coupled together, and the inner casing part 116 may consist of a first inner casing part 116a to be coupled to the first outer casing part 115a, and a second inner casing part 116b to be coupled to the second outer casing part 115b.

In the meantime, partition receptacles 111 may be provided between the outer casing part 115 and the inner casing part 116 to respectively accommodate the force-feedback provision units 120 therein. Further, although the communication unit 130, the force-feedback provision unit 120, the processor unit 140, and the power supply 150 may be installed between the outer casing part 115 and the inner casing part 116, the present invention is not limited thereto. For example, when a photovoltaic cell is used as the power supply 150, the photovoltaic cell may be installed directly or indirectly on an outer surface of the casing 110.

According to an embodiment, the partition receptacle 111 provided between the outer casing part 115 and the inner casing part 116 may be coupled to the inner casing part 116. Here, the partition receptacle 111 may have an opening (not shown) on an upper portion thereof, and the inner casing part 116 to be coupled to the upper portion of the partition receptacle 111 may have a hole 112 corresponding to the opening, so that the first end of the force-feedback provision unit 120 accommodated in a space of the partition receptacle 111 protrudes into the inner casing part 116 through the opening and the hole 112, thereby providing force feedback to the user's finger inserted into the inner casing part 116.

FIG. 4 is a view illustrating the configuration of a force-feedback provision unit 120 for providing a user with the sensation of touch according to embodiments of the present invention.

As illustrated in FIG. 4, the force-feedback provision unit 120 according to embodiment of the present invention may nonexclusively include a pin section 121, an actuator 122, an elastic member 123, and a vibration-absorption member 124.

Specifically, the pin section 121 is an element that serves to transfer the sensation of touch directly or indirectly to at least a portion of the user's body.

The actuator 122 may be installed such that an upper end thereof is operatively associated with at least a portion of a lower end of the pin section 121, and a lower end thereof is operatively associated with at least a portion of the elastic member 123 in order to vibrate the pin section 121 under the control of the processor unit 140.

Here, since at least a portion of the elastic member 123 is coupled to the outer casing part 115a, 115b, the elastic member 123 can support the actuator 122 such that vibrations generated by the actuator 122 can be transferred not towards the lower end (i.e., a direction towards the outer casing part), but towards the upper end of the actuator 122. Here, an upper end of the pin section 121 can protrude into the inner casing part 116 through the hole 112 shown in FIG. 3 according to vibrations generated by the actuator, thereby providing force feedback to a specified part of the user's body.

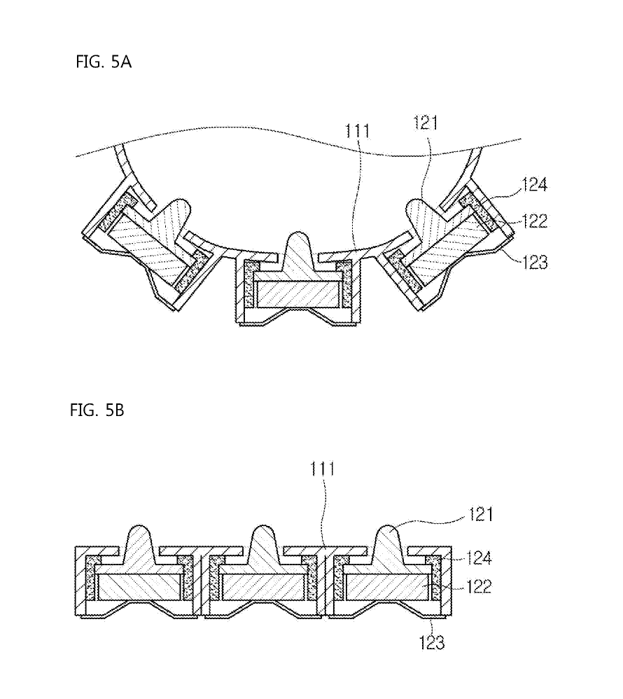

The vibration-absorption member 124 may have a structure surrounding at least a portion of the pin section 121 and the actuator 122, so that the vibration-absorption member can prevent vibrations generated by the actuator 122 from being transferred to a portion other than the specified part of the user's body with which the pin section 121 facing the actuator 122 comes into contact. Here, the partition receptacle 111 coupled directly or indirectly to at least a portion of an outer surface of the vibration-absorption member 124 may also prevent vibrations generated by the force-feedback provision unit 120 from being transferred to a portion other than the specified part of the user's body. This will be described later with reference to FIG. 5.

The structure shown in FIG. 4 will now be described in detail.

A first space is formed between a lateral side of the actuator 122 and an inner side of the vibration-absorption member 124 so as to allow the actuator 122 to vibrate horizontally in the first space, and a second space is formed between the inner side of the vibration-absorption member 124 and an outer side of the pin section 121 so as to allow the pin section 121 to vibrate vertically in the second space by the action of the actuator 122.

When the force-feedback provision apparatus 100 is provided with the plurality of force-feedback provision units 120, the vibration-absorption member 124 can prevent horizontal vibrations generated in the first space by the actuator 122 from being transferred to another force-feedback provision unit 120 adjoining to the force-feedback provision unit 120 shown in FIG. 4 and also allow vibrations to be transferred upwards. This is because at least a portion of the lower end of the actuator 122 is operatively associated with at least a portion of the upper end of the elastic member 123 and the actuator 122 is supported upwards by a restoration force of the elastic member 123 so as to allow vibrations to be transferred upwards.

In the meantime, the vibration-absorption member 124 may be formed from a silicone rubber pad, the actuator 122 may be any one of a vibration motor, a linear motor, a VCM motor, a step motor, a servo motor, a solenoid valve, and a source of hydropneumatic pressure, and the elastic member 123 may be a spring. In the case of the force-feedback provision unit 120 shown in FIG. 4, however, the vibration-absorption member 124 adopts a silicone rubber pad, the actuator 122 adopts a rotary vibration motor, and the elastic member 123 adopts leaf springs. Here, an upper portion of at least one of the leaf springs is installed to be operatively associated with at least a portion of the lower end of the actuator 122, and a lower portion of at least one of the leaf springs is coupled directly or indirectly to the casing (see 115a, 115b in FIG. 3).

Referring again to FIG. 3, the communication unit 130 and the processor unit 140 may be coupled directly or indirectly to the casing 110. The communication unit 130 may carry out communication with the external terminal 200, and the processor unit 140 may perform (i) a process of receiving at least one of: a first force-feedback control data generated based on vector information on a motion of the at least a portion of the user's body wearing the casing 110 and information on the virtual object 300; and a second force-feedback control data generated based on image information on a motion of the at least a portion of the user's body wearing the casing 110 and information on the virtual object 300, from the external terminal 200 via the communication unit 130 so as to control the force-feedback provision unit 120, or (ii) a process of generating at least one of the first and second force-feedback control data so as to control the force-feedback provision unit 120. Here, the vector information means information indicative of angular velocity, acceleration, a direction, a location, etc., and the information on the virtual object means information indicative of a position, a size, a shape, etc. of the virtual object 300 in the virtual space.

The processes (i) and (ii) performed by the processor unit 140 will be described in detail.

First, the process (i) will now be described.

The force-feedback provision apparatus 100 may further include a sensor unit (not shown), such as a gyroscope sensor, an acceleration sensor, etc., which is coupled directly or indirectly to the casing 110 so as to sense vector information according to a motion of at least a portion of the user's body. In this case, the processor unit 140 is configured to acquire vector information from the sensor unit; transmit the acquired information to the external terminal 200 via the communication unit 130 so as to determine a touch state between the at least a portion of the user's body and the virtual object 300 based on the vector information and the information on the virtual object; and if it is determined that the at least a portion of the user's body and the virtual object 300 are in contact, receive the first force-feedback control data generated based on the vector information and the information on the virtual object via the communication unit 130 so as to control the force-feedback provision unit 120.

Further, the processor unit 140 may be configured to, when the external terminal 200 generates the second force-feedback control data based on image information of a motion of the at least a portion of the user's body and the information on the virtual object 300, receive the second force-feedback control data from the external terminal 200 so as to control the force-feedback provision unit 120. Here, the image information may be an image itself that is picked up by a camera operatively associated with the external terminal 200, or information on an image picked up by the camera operatively associated with the external terminal 200 and then image-processed.

Next, the process (ii) will be described in detail.

The processor unit 140 may perform the process of acquiring vector information from the sensor unit; acquiring information on the virtual object 300 from the external terminal 200 via the communication unit 130; and determining a touch state between the at least a portion of the user's body and the virtual object 300 based on the vector information and the information on the virtual object. If it is determined that the at least a portion of the user's body and the virtual object 300 are in contact, the processor unit 140 may generate the first force-feedback control data based on the vector information and the information on the virtual object so as to control the force-feedback provision unit 120. Further, the processor unit 140 may perform the process of acquiring image information of a motion of the at least a portion of the user's body and information on the virtual object 300 from the external terminal 200 via the communication unit 130, and determining whether the at least a portion of the user's body and the virtual object 300 are in contact or not. If it is determined that the at least a portion of the user's body and the virtual object 300 are in contact, the processor unit may generate the second force-feedback control data based on the image information and the information on the virtual object so as to control the force-feedback provision unit 120.

FIGS. 5A and 5B are cross-sectional views illustrating an assembly of a plurality of force-feedback provision units 120 for providing a user with the sensation of touch according to embodiments of the present invention.

As illustrated in FIGS. 5A and 5B, a plurality of force-feedback provision units 120 is provided in the force-feedback provision apparatus 100.

Although FIGS. 5A and 5B show similar configurations, FIG. 5A shows a configuration in which the force-feedback provision units 120 are arranged in a curved pattern, and FIG. 5B shows a configuration in which the force-feedback provision units 120 are linearly arranged parallel with each other.

Referring to FIGS. 5A and 5B, the plurality of force-feedback provision units 120 are respectively coupled to the partition receptacles 111 so as to prevent vibrations from being transferred between the adjoining force-feedback provision units 120.

In the meantime, in the case where the plurality of force-feedback provision units 120 is installed in the force-feedback provision apparatus 100 as shown in FIGS. 5A and 5B, the processor unit 140 can perform a control operation on the force-feedback provision unit 120 among the plurality of force-feedback provision units 120 that correspond to the interaction with the virtual object 300.

If at least a portion of the user's body interacts with a specified portion of the virtual object 300 in a single contact state without a motion, the processor unit 140 may perform a control operation only on the force-feedback provision unit 120 corresponding to the interaction, thereby enabling the user to realize the sensation of touch occurring at a point at which the user touches a real object. For example, if the user's finger wearing the force-feedback provision apparatus 100 is brought into contact with a specified portion of the virtual object 300 without a change in direction of the finger, the processor unit may perform a control operation only on a single force-feedback provision unit 120 (e.g. the force-feedback provision unit on the lower side) of the plurality of force-feedback provision units 120 that correspond to the interaction with the virtual object 300, thereby providing the user with stationary sensation of touch. Here, the processor unit 140 may control the actuator 122 of the force-feedback provision unit 120 to provide a different level of intensity of vibrations according to an inclined angle of the user's body (e.g. finger) or a shape, texture, etc. of the virtual object.

Further, in a case where at least a portion of the user's body interacts with a specified portion of the virtual object 300 in a single contact state without a motion (assuming that the force-feedback provision unit 120 corresponding to the interaction with the virtual object 300 is one disposed on the lower side as illustrated in the above paragraph), and the at least a portion of the user's body is moved on the virtual object 300 while maintaining the single contact state (i.e. the state of the finger being maintained in a fixed direction), if the user holds that portion of the his or her body contacting the virtual object 300 at the same position (i.e. if even during moving, a lower side one is maintained as the force-feedback provision unit 120 corresponding to the interaction with the virtual object 300), the processor unit 140 can manipulate the virtual object 300 while maintaining a constant force or sensation of touch, since the actuator 122 to be controlled does not change.

Further, in a case where at least a portion of the user's body interacts with a specified region of the virtual object 300 in a multi-contact state while moving on the virtual object, the processor unit 140 may control the N force-feedback provision units sequentially in a direction opposite the direction in which the at least a portion of the user's body moves, thereby enabling the user to perceive a sense of direction occurring at a contact surface when the user moves while touching a real object. For example, when a user's finger wearing the force-feedback provision apparatus 100 is moved from the left side to the right side with a specified surface thereof brought into contact with the virtual object 300, 3 force-feedback provision units 120 of the plurality of force-feedback provision units 120 that correspond to the interaction with the virtual object 300 are controlled sequentially from the right side to the left side, thereby providing dynamic sensation of touch to the user. Here, the processor unit 140 may individually control the 3 force-feedback provision units 120 to generate a different level of intensity of vibrations from the actuator 122. Assuming that the 3 force-feedback provision units 120 are called A, B, and C from the right side, and a level of the intensity of the actuator 122 is put in parentheses as numbers like 4 (highest level), 3 (high level), 2 (middle level), and 1 (low level), the force-feedback provision units can be controlled sequentially from A so as to provide a sense of direction to the user as follows:
A(4)B(0)C(0)→A(3)B(1)C(0)→A(2)B(3)C(0)→A(1)B(1)C(0)→A(0)B(0)C(1)→A(0)B(0)C(0).

While the present invention has been described with reference to specific configurations, such as elementary components, exemplary embodiments, and drawings, the description is provided merely for assisting more generalized understanding of the invention, so the present invention is not limited to the above-mentioned embodiments. An ordinary person skilled in the art may appreciate that such embodiments can be changed and modified into a variety of other forms through the description.

Therefore, it should be understood that the idea of the present invention is not defined as being limited to the exemplary embodiments, and such changes and modifications fall within the scope of the present invention defined by following claims and equivalents thereof.

What is claimed is:

1. An apparatus for providing haptic force feedback to a user interacting with a virtual object in a virtual space, the apparatus comprising:
a casing wearable around at least a portion of the user's body;
a force-feedback provision unit coupled directly or indirectly to the casing and having a first end directly or indirectly touching at least a portion of the user's body and a second end coupled directly or indirectly to the casing through an elastic member to allow the first end to provide a sensation of touch arising from an interaction with the virtual object to the at least a portion of the user's body;
a communication unit coupled directly or indirectly to the casing to communicate with an external terminal; and
a processor unit coupled to directly or indirectly to the casing and configured to perform (i) a process of receiving at least one of: a first force-feedback control data generated based on vector information on a motion of the at least a portion of the user's body wearing the casing and information on the virtual object; and a second force-feedback control data generated based on image information on a motion of the at least a portion of the user's body wearing the casing and information on the virtual object, from the external terminal via the communication unit so as to control the force-feedback provision unit, or (ii) a process of generating at least one of the first and second force-feedback control data so as to control the force-feedback provision unit.

2. The apparatus according to claim 1, wherein the force-feedback provision unit includes:
a pin section serving to transfer the sensation of touch directly or indirectly to the at least a portion of the user's body; and
an actuator provided such that an upper end thereof is operatively associated with at least a portion of a lower end of the pin section so as to vibrate the pin section under the control of the processor unit,
wherein the elastic member is provided to support the actuator such that at least a portion of an upper end thereof is operatively associated with a lower end of the actuator, such that vibrations generated by the actuator are able to be transferred not towards the lower end, but towards the upper end of the actuator.

3. The apparatus according to claim 2, wherein the force-feedback provision unit further includes:
a vibration-absorption member surrounding at least a portion of the pin section and the actuator so as to prevent vibrations generated by the actuator from being transferred to a portion other than a specified part of the user's body with which the pin section facing the actuator comes into contact.

4. The apparatus according to claim 3, comprising a partition receptacle coupled directly or indirectly to a portion of the vibration-absorption member at a lateral side thereof so as to prevent vibrations generated by the force-feedback provision unit from being transferred to a portion other than the specified part of the user's body, wherein an upper portion thereof has a hole through which at least a portion of the pin section passes.

5. The apparatus according to claim 3, wherein a first space is formed between a lateral side of the actuator and an inner side of the vibration-absorption member so as to allow the actuator to vibrate horizontally in the first space, and
wherein a second space is formed between the inner side of the vibration-absorption member and an outer side of the pin section so as to allow the pin section to vibrate vertically in the second space by the action of the actuator.

6. The apparatus according to claim 4, wherein the apparatus is provided with a plurality of force-feedback provision units, and wherein partition receptacles for the respective force-feedback provision units serve to absorb vibrations from adjoining force-feedback provision units and prevent the vibrations from being transferred therebetween.

7. The apparatus according to claim 2, wherein the apparatus is provided with a plurality of force-feedback provision units, and wherein, when the at least a portion of the user's body interacts with a specified portion of the virtual object in a single contact state and the at least a portion of the user's body is moved on the virtual object while maintaining the single contact state, the processor unit performs a control operation on the force-feedback provision unit of the plurality of force-feedback provision units that corresponds to the interaction with the virtual object.

8. The apparatus according to claim 2, wherein the apparatus is provided with a plurality of force-feedback provision units, and wherein, when the at least a portion of the user's body interacts with a specified portion of the virtual object in a multi-contact state and the at least a portion of the user's body is moved on the virtual object while maintaining the multi-contact state, the processor unit performs a control operation on N force-feedback provision units of the plurality of force-feedback provision units that correspond to the interaction with the virtual object such that the N force-feedback provision units are controlled sequentially in a direction opposite the direction in which the at least a portion of the user's body moves.

9. The apparatus according to claim 2, wherein the actuator is any one of a vibration motor, a linear motor, a VCM motor, a step motor, a servo motor, a solenoid valve, and a source of hydropneumatic pressure.

10. The apparatus according to claim 2, wherein the elastic member includes leaf springs, wherein a lower portion of at least one of the leaf springs is coupled directly or indirectly to the casing, and an upper portion of at least one of the leaf springs is operatively associated with at least a portion of the lower end of the actuator.

11. The apparatus according to claim 1, further comprising a sensor unit coupled directly or indirectly to the casing so as to sense vector information according to a motion of the at least a portion of the user's body, and
wherein the processor unit is configured to acquire the vector information from the sensor unit; acquire information on the virtual object from the external terminal via the communication unit;
determine a touch state between the at least a portion of the user's body and the virtual object based on the vector information and the information on the virtual object; and, if it is determined that the at least a portion of the user's body and the virtual object are in contact, generate the first force-feedback control data based on the vector information and the information on the virtual object.

12. The apparatus according to claim 1, further comprising a sensor unit coupled directly or indirectly to the casing so as to sense vector information according to a motion of the at least a portion of the user's body, and
wherein the processor unit is configured to acquire the vector information from the sensor unit and transmit the acquired information to the external terminal via the communication unit such that the external terminal determines a touch state between the at least a portion of the user's body and the virtual object based on the vector information and the information on the virtual object, and if the external terminal determines that the at least a portion of the user's body and the virtual object are in contact, the processor unit is configured to receives the first force-feedback control data generated based on the vector information and the information on the virtual object via the communication unit.

13. The apparatus according to claim 1, wherein the processor unit is configured to acquire image information of a motion of the at least a portion of the user's body and information on the virtual object from the external terminal via the communication unit; determine whether the at least a portion of the user's body and the virtual object are in contact or not; and, if it is determined that the at least a portion of the user's body and the virtual object are in contact, generate the second force-feedback control data based on the image information and the information on the virtual object.

14. The apparatus according to claim 1, wherein the casing has an outer casing part and an inner casing part that is able to be coupled together, wherein a partition receptacle is provided between the outer casing part and the inner casing part to accommodate the force-feedback provision unit therein.

15. The apparatus according to claim 14, wherein the outer casing part has first and second outer casing parts that are able to be coupled together, wherein the inner casing part has a first inner casing part to be coupled to the first outer casing part, and a second inner casing part to be coupled to the second outer casing part.

16. The apparatus according to claim 14, wherein the partition receptacle has an opening on an upper portion thereof, and the inner casing part to be coupled to the upper portion of the partition receptacle has a hole corresponding to the opening such that the first end of the force-feedback provision unit passes through the opening and the hole.

17. The apparatus according to claim 16, wherein the force-feedback provision unit includes: a pin section serving to transfer the sensation of touch directly or indirectly to the at least a portion of the user's body; and an actuator provided such that an upper end thereof is operatively associated with at least a portion of a lower end of the pin section so as to vibrate the pin section under the control of the processor unit,
wherein the upper end of the pin section vibrates and moves through the hole with the action of the actuator, thereby providing the sensation of touch according to the interaction with the virtual object to a specified portion of the user's body with which the pin section facing the actuator comes into contact.

18. The apparatus according to claim 17, wherein at least a portion of the elastic member is operatively associated with the lower end of the actuator, and at least a portion of the elastic member is coupled to the outer casing part.
